(19) United States
(12) Patent Application Publication
(10) Pub. No.: US 2025/0005380 A1
(43) Pub. Date: Jan. 2, 2025

(54) DECISION TREE BASED DATA VALIDATION AND PREDICTION

(71) Applicant: Precisely Software Incorporated, Burlington, MA (US)

(72) Inventor: Mariappan Asokan, Millburn, NJ (US)

(21) Appl. No.: 18/216,199

(22) Filed: Jun. 29, 2023

(51) Int. Cl. G06N 5/01; G06N 5/022

(52) U.S. Cl. CPC G06N 5/01; G06N 5/022

(57) ABSTRACT

A computer-implemented method to predict possible values for a subset of attributes of a record being interactively completed includes receiving a first value of a first attribute of the record. Further, from a decision tree, a first tree-level associated with the first attribute is determined. Further, in the decision tree, one or more nodes at a second tree-level are identified based on an index of the first tree-level. The index of the first tree-level includes a mapping between the first value and the nodes from the second tree-level based on historical records used to generate the decision tree data structure. Further, several paths in the decision tree are traversed, including a path from each of the nodes at the second tree-level towards a root node of the decision tree. The method also includes computing probabilities of the paths, and outputting values of the subset of attributes of the record along the path with highest probability as the possible values.

### BACKGROUND

This disclosure relates in general to the field of computer systems and, more particularly, to techniques for building an improved decision tree data structure for data validation and prediction. The decision tree data structure is generated using unsupervised machine learning in some aspects.

In several fields, such as the supply chain, industrial, medical, sales, etc., voluminous amounts of data may be generated and collected for each record. This data may include several attributes for each record. For example, a supply chain record of a product may include a product identifier, a plant identifier where the product was manufactured, a bin size indicative of a number of products manufactured in a batch, particular characteristics of the product, and other such information. For example, in the case of a medical record of a patient, the record may include the patient's identifier, age, gender, height, weight, smoking history, geographic location, and other, non-medical information. Several other types of records with additional and/or different attributes can be used in other fields, and even in the fields noted above.

Despite this wealth of data, there is a dearth of meaningful ways to compile and analyze the data quickly, efficiently, and comprehensively. Thus, what are needed are a user interface, system, and method that overcome one or more of these challenges.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method to predict possible values for a subset of a plurality of attributes of a record when the record is being interactively completed. The computer-implemented method also includes receiving, by a processor, via a user-interface, a first value corresponding to a first attribute of the record being completed. The method also includes determining, by the processor, in a decision tree data structure, a first tree-level associated with the first attribute, the decision tree data structure may include a plurality of tree-levels corresponding to the plurality of attributes, respectively. The method also includes identifying, by the processor, in the decision tree data structure, one or more nodes at a second tree-level based on an index of the first tree-level, where the index of the first tree-level may include a mapping between the first value of the first attribute and the one or more nodes from the second tree-level based on historical records used to generate the decision tree data structure. The method also includes traversing, by the processor, one or more paths in the decision tree data structure, where a path is traversed from each of the one or more nodes at the second tree-level towards a root node of the decision tree data structure. The method also includes computing, by the processor, probabilities of the one or more paths. The method also includes outputting, by the processor, the values of the subset of plurality of attributes of the record along the path with highest probability as the possible values. Other embodiments of this aspect include corresponding computer systems, apparatus, and computer programs recorded on one or more computer storage devices, each configured to perform the actions of the methods.

One general aspect includes a computing apparatus. The computing apparatus includes a processor, and a memory storing instructions that, when executed by the processor, configure the apparatus to predict possible values for a subset of a plurality of attributes of a record when the record is being interactively being completed. The apparatus receives a first value corresponding to a first attribute of the record being completed. The apparatus further determines, in a decision tree data structure, a first tree-level associated with the first attribute, the decision tree data structure may include a plurality of tree-levels corresponding to the plurality of attributes, respectively. The apparatus further identifies, in the decision tree data structure, one or more nodes at a second tree-level based on an index of the first tree-level, where the index of the first tree-level may include a mapping between the first value of the first attribute and the one or more nodes from the second tree-level based on historical records used to generate the decision tree data structure. The apparatus traverses, one or more paths in the decision tree data structure, where a path is traversed from each of the one or more nodes at the second tree-level towards a root node of the decision tree data structure. The apparatus computes probabilities of the one or more paths. The apparatus outputs values of the subset of plurality of attributes of the record along the path with highest probability as the possible values. Other embodiments of this aspect include corresponding computer systems, apparatus, and computer programs recorded on one or more computer storage devices, each configured to perform the actions of the methods.

One general aspect includes a non-transitory computer-readable storage medium including instructions that when executed by a computer, cause the computer to perform one or more operations. The operations include receiving via a user-interface, a first value corresponding to a first attribute of a record being completed. The operations include determining in a decision tree data structure, a first tree-level associated with the first attribute, where the decision tree data structure may include a plurality of tree-levels corresponding to the plurality of attributes, respectively. The operations include identifying in the decision tree data structure, one or more nodes at a second tree-level based on an index of the first tree-level, where the index of the first tree-level may include a mapping between the first value of the first attribute and the one or more nodes from the second tree-level based on historical records used to generate the decision tree data structure. The operations include traversing one or more paths in the decision tree data structure, where a path is traversed from each of the one or more nodes at the second tree-level towards a root node of the decision tree data structure. The operations include computing probabilities of the one or more paths. The operations include outputting the values of the subset of plurality of attributes of the record along the path with highest probability as possible values. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates an aspect of the subject matter in accordance with an embodiment.

FIG. 2 illustrates an aspect of the subject matter in accordance with an embodiment.

FIG. 3 illustrates an aspect of the subject matter in accordance with an embodiment.

FIG. 4 illustrates an aspect of the subject matter in accordance with an embodiment.

FIG. 5 illustrates an aspect of the subject matter in accordance with an embodiment.

FIG. 6 illustrates an aspect of the subject matter in accordance with an embodiment.

FIG. 7 illustrates a method 700 in accordance with an embodiment.

FIG. 8 illustrates an aspect of the subject matter in accordance with an embodiment.

FIG. 9 illustrates an aspect of the subject matter in accordance with an embodiment.

FIG. 10 illustrates an aspect of the subject matter in accordance with an embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. It, however, will be clear and apparent that the subject technology is not limited to the specific details set forth herein and may be practiced without these specific details. In some instances, well-known structures and components are shown in block diagram form to avoid obscuring the concepts of the subject technology.

The terms “computer”, “processor”, “computer processor”, “compute device”, “processing unit”, “central processor”, or the like should be expansively construed to cover any kind of electronic device with data processing capabilities including, by way of non-limiting example, a digital signal processor (DSP), a microcontroller, a field programmable gate array (FPGA), an application specific integrated circuit (ASIC), or any other electronic computing device comprising one or more processors of any kind, or any combination thereof.

As used herein, the phrase “for example,” “such as,” “for instance” and variants thereof describe non-limiting embodiments of the presently disclosed subject matter. Reference in the specification to “for example,” “such as,” “for instance” or variants thereof means that a particular feature, structure, or characteristic described in connection with the embodiment(s) is included in at least one embodiment of the presently disclosed subject matter. Thus, the appearance of the phrase “for example,” “such as,” “for instance” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, can also be provided separately or in any suitable sub-combination.

Data collection is undertaken for a variety of reasons, such as to document/monitor system performance (such as a manufacturing plant performance), to monitor usage (such as use of resources through supply chain logistics), or to predict characteristics for decision making (such as to predict a purchase order based on historic trend), etc. A variety of data manipulation techniques allows information to be extracted from a data set, such as trend curve analysis, statistical analysis, feature extraction, etc. Such analysis is commonly used to identify or characterize anomalous events, for example, when a deviation from a tendency is observed. Data set characterization can require substantial user input and knowledge of the data set. To overcome the need for user supervision or input, data set manipulation techniques have been developed that attempt to learn from a training data set, such as those using machine learning techniques like artificial neural-networks, Kohonen's self-organizing maps, fuzzy classifiers, symbolic dynamics, multivariate analysis, and others.

In computer science, “decision trees” are used to implement classification and regression techniques to infer classification rules in the form of decision tree representations from a set of unordered, irregular instances. In typical decision tree-based implementations, the decision tree classification algorithm adopts a top-down recursion mode, compares attribute values among nodes in the decision tree, judges downward branches from the nodes according to different attribute values, and obtains a classification result when judging to leaf nodes. The nodes in the decision tree represent an attribute, the test results are output in the branches of the leaf nodes, and the results corresponding to different conditions are further verified in the nodes of the next layer. Therefore, each path from the root to the leaf node of the decision tree corresponds to a selection method, and the closer the node attribute weight value is to the root, the higher the node attribute weight value is, the whole decision tree corresponds to a set of expression rules.

One of the crucial components of the process of decision tree generation is how to select attributes to construct the decision tree, and this belongs to the problem of NP difficulty, so that only heuristic strategies can be adopted to select the attributes. The attribute selection depends on the method of impurity metric for various sample subsets, including information gain, information gain ratio, evidence weight, minimum description length, etc. Because real-world data is generally imperfect, a corresponding metric method is selected according to the problem and the attribute field characteristics.

Commonly, an Iterative Dichotomiser 3 (ID3) algorithm is used for constructing a decision tree from a dataset by taking entropy and information gain as metrics. The ID3 algorithm uses information entropy as heuristic knowledge on a sample set to select appropriate classification attributes to implement the operation of dividing the sample set into subsets. In ID3, nodes of the decision tree layer are constructed by selecting the attribute with the highest information entropy as a priority classification condition for the sample set. By the ID3 method, the attribute with the highest information entropy is used for dividing the sample set contained in the current node, so that the attribute mixing degree of all generated sample subsets is reduced to the minimum. In order to find the optimal way to classify samples, the number of questions to be asked when constructing the decision tree should be minimized, i.e., to reduce the depth of the tree, the information gain function is used to provide such a balanced partitioning in ID3. The ID3 algorithm is a “greedy algorithm” that constructs a decision tree using a top-down, divide- and -conquer recursive approach. The termination conditions for this recursion are all samples within a node belonging to the same class. If no attribute is available to partition the current sample set, then voting principle is used to make it a mandatory leaf node and mark it as the sample type with the most categories. However, such dependence on the features, and marking the attribute with the largest attribute value is not necessarily optimal. In other words, for problems with more factors need to be considered in practical situations, the conventional ID3 algorithm has a deficiency in determining the priority of the attribute, which is often derived from the fact that the information entropy of the attribute with more options is higher.

Therefore, conventional techniques adopt a modified ID3 algorithm to avoid such problems, such as analyzing and calculating the sensitivity of the attribute to give more reasonable attribute weight, performing quadratic evaluation integration on the decision tree nodes by using a joint density function based on the information entropy, and the like. In such modified algorithms, the sensitivity calculation leads out a corresponding neural network according to the input attribute value and trains the neural network, so that the complexity of the algorithm is improved, however, the efficiency of the algorithm is not high; analysis using the joint density function is only applicable to discrete data and is not necessarily compatible with all of the data, such as that handled by embodiments described herein. Similar drawbacks exist in the case of other algorithms, such as C4.5 (extension of ID3), Random Forest, Gradient Boosting Trees, etc. that can generate decision trees based on a set of records as training data.

Further, the existing decision tree constructing algorithms are not optimal for use in predicting attribute values based on historic data. The existing algorithms require an explicit target attribute and construct a decision tree specific to the target attribute to predict values for such target attribute. In the absence of a target attribute, several trees must be built by choosing each attribute as a pseudo target attribute. Thus, if there are N attributes, N trees must be built. When a new record is to be added to the training set, the cost of building N trees is huge. Here, “cost” includes computing cost, such as the computing resources (e.g., processor, memory, etc.), time (both, computing time and user time), along with monetary costs. Also, given any subset of attribute values as features, finding possible values for other attributes as targets requires traversing several trees, which adds to the computing costs and time. Therefore, technical challenges exist with constructing the decision tree data structures using existing algorithms. Further technical challenges exist in using decision tree data structures for predicting attribute values and/or validating input attribute values because of the compute costs and time required. Prediction and validation based on decision tree data structures involves traversing the decision tree data structures, which in the existing techniques as explained above, is a costly operation.

Further yet, conventionally, the decision tree construction is performed using supervised algorithms. For example, machine learning systems are provided labeled historic data and corresponding decision trees and the above-mentioned algorithms are executed in a supervised manner to compare output(s) with the pre-built decision tree(s) and correct one or more operating parameters until the output decision tree(s) match(es) the pre-built decision tree(s).

Embodiments described herein provide technical solutions that address such technical challenges with constructing and using decision trees, particularly for validation and prediction of attribute values. The technical solutions described herein facilitate an unsupervised decision tree building algorithm which does not require any target attribute. Further, the technical solutions described herein facilitate, given a set of attribute values, predicting possible values for other attributes without traversing several trees, rather traversing only a single decision tree data structure.

Technical solutions described herein are rooted in computing technology, particularly, constructing and using decision tree data structures from datasets. Technical solutions described herein provide several advantages and improvements to computing technology, and particularly to constructing and using decision tree data structures. For example, technical solutions described herein facilitate an unsupervised algorithm that generates only one (single) decision tree for a record containing several attributes. Further, the single decision tree data structure can predict attribute values (“values”) for any of the attributes, without requiring building the decision tree data structure with a particular target attribute. Embodiments of the technical solutions described herein further provide several practical applications. For example, embodiments described herein provide better prediction performance, which is particularly important for interactive use cases, such as when filling out a form (e.g., web-based form) where a user enters only a subset of fields of a record, and the decision tree data structure is used to provide guidance on what can be entered in other fields of the record in real time. As described in detail further, because of the combination of a single tree and an indexing technique, performance of the technical solutions described herein facilitates real time prediction of such attribute values that are used to guide the input in the fields. As noted herein, using the single decision tree data structure (instead of multiple trees corresponding to the multiple attributes) is important for such real time performance.

The real time performance provided by the technical solutions described herein also facilitates the technical solutions to be used for validating input values in real time. For example, as the user enters values of one or more attributes, such as through a web form or any other user-interface, the input can be validated based on the decision tree data structure. In turn, the result of the validation can be provided to the user, for example, to correct one or more inputs.

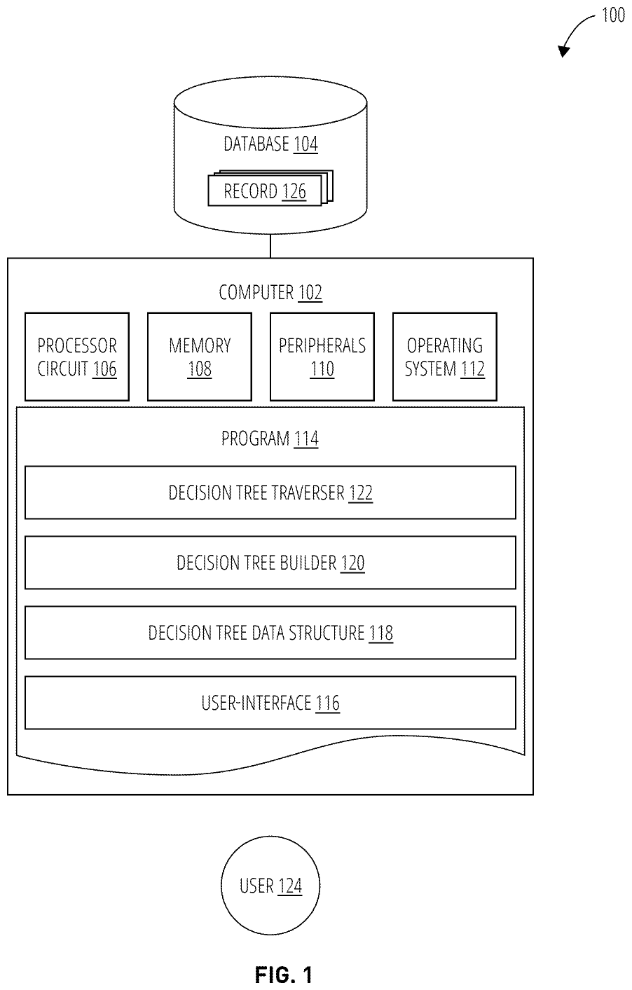

Referring to FIG. 1, an example system 100 is depicted that facilitates prediction and validation of attribute values as a record is being completed or input by a user according to one or more embodiments. A user 124 of the system 100 is also depicted. Although a single user 124 is depicted, it is understood that there can be several users 124 accessing the system 100 at any instant. The user 124 can be an end-user of the system 100, a developer of the system 100, an administrator of the system 100, or take on any other role associated with the system 100.

The system 100 includes at least a computer 102 and a database 104 among other components. It is understood that the system 100 can include additional elements, such as communication network related components, additional databases, additional computers, electrical power circuitry, etc., which are not depicted, but which will be evident to a reader.

The computer 102 includes a processor circuit 106, a memory 108, one or more peripherals 110, an operating system 112, and a computer program 114, among other components. Although the components are depicted in the singular, it is understood that embodiments of the technical solutions herein can include some of the components in the multiple.

The processor circuit 106 can include one or more processing units, such as a central processing unit, a graphics processing unit, a digital signal processor, an arithmetic logic unit, or any other processing circuitry that can read and execute computer instructions, typically referred to as computer programs, software, firmware, etc.

The memory 108 can include volatile and/or non-volatile memory devices, such as random access memory, read only memory, hard disk drive, solid state drive, etc. In some examples, the memory 108 stores one or more computer executable instructions that are executed by the processor circuit 106. The processor circuit 106 may use the memory 108 to store intermediate and/or final results during or after execution of the computer instructions.

The peripherals 110 can include one or more auxiliary elements, such as input/output (I/O) devices, wires, circuits, interfaces, etc., that enable a user 124 to operate and/or use the computer 102. Examples of the peripherals 110 include but are not limited to a keyboard, a mouse, a joystick, a touchscreen, a peripheral component interface (PCI), a small computer system interface (SCSI), a universal serial bus (USB) interface, an I/O port, a network interface, a display device, a memory interface, an application specific integrated circuit (ASIC), or any other auxiliary device that enables the use of the computer 102.

The operating system 112 enables the one or more components of the computer 102 to manage hardware and software resources, and provides common services for computer programs, such as program 114. The operating system 112 acts as an intermediary between software and hardware to provide functions such as input, output, memory allocation, etc. The operating system 112, as used herein, can include drivers, application programming interfaces (APIs) and other elements that facilitate operating the components of the computer 102. Examples of the operating system 112 can include MICROSOFT® WINDOWS®, LINUX®, IBM® Z®, etc. The operating system 112 provides one or more APIs to enable the program 114 to access one or more resources of the computer 102 and other resources accessible to the computer 102, such as a database 104.

The program 114 is a computer program product that includes one or more computer executable instructions. The processor circuit 106 reads and executes the computer executable instructions to perform one or more operations specified by the program 114. The program 114 may be stored in the memory 108. The program 114 may include computer executable instructions in one or more computer programming language, and the type of language used does not limit the technical solutions described herein. The program 114, when executed, can include computer executable instructions that provide a practical application to a user 124 by using the computer 102. The program 114 can include computer executable instructions that cause the processor circuit 106 to perform a specific sequence of operations in parallel or in real time that provides significantly more than a post-solution activity.

In some embodiments, the program 114, when executed by the computer 102, facilitates the user 124 to interact with a database 104. The database 104 may be part of the computer 102 in some embodiments. The database 104 is a repository of digital data stored in the form of records 126. The database 104 can be hosted on computer clusters, cloud storage, file systems, or any type of database storage system. The database 104 includes a database management system (DBMS) that facilitates interaction with the records 126 stored in the database 104. The database 104 can store the records 126 using any type of a database models, such as a relational database, a non-relational database, etc. The database 104 can store any type of data, and aspects of the technical solutions described herein are not limited by the type of data stored in the database 104. While specific examples of records 126 are used for explanation of the technical solutions herein, it is understood that the technical solutions are not limited to those specific types, structures, or descriptions of records used in the examples herein.

In some embodiments, the program 114 facilitates transforming data (e.g., stored in database 104) to a specific format (e.g., decision tree data structure 118) for optimal (in real time) processing of the data. Further, the program 114 facilitates processing data (e.g., decision tree data structure 118) in a specific manner to provide optimal (real time) results to a user 124. Accordingly, the program 114 enables the computer 102 to be a non-generic computer.

The program 114 includes a user-interface 116, a decision tree data structure 118, a decision tree builder 120, and a decision tree traverser 122, among other components.

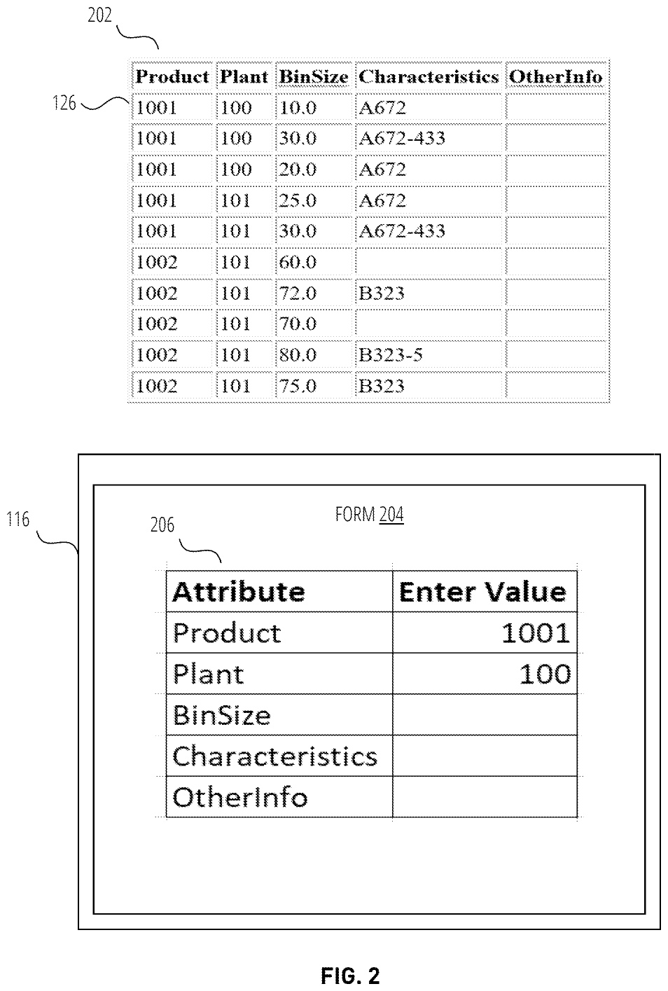

The user-interface 116 facilitates the user 124 to interact with the computer program 114, and in turn, the computer 102. The user-interface 116 may enable the user 124 to execute the computer program 114 (or application, or software) on the computer 102. The user 124 can provide input, which includes instructions and/or data to the computer 102 for executing the program 114. The user-interface 116 can provide output to the user 124 based on the execution of the instructions. The user-interface 116 can be a graphical user interface, a command line interface, an audio interface, etc. The user-interface 116 can receive input via operations of one or more I/O devices, such as a keyboard, a mouse, a touchscreen, a microphone, a joystick, a digital pen, etc. The user-interface 116 can provide output via operations of one or more I/O devices, such as a monitor, a touchscreen, a projector, a speaker, a controller etc. FIG. 2 depicts an example user-interface 116. It is understood that the user-interface 116 is not limited to the illustration.

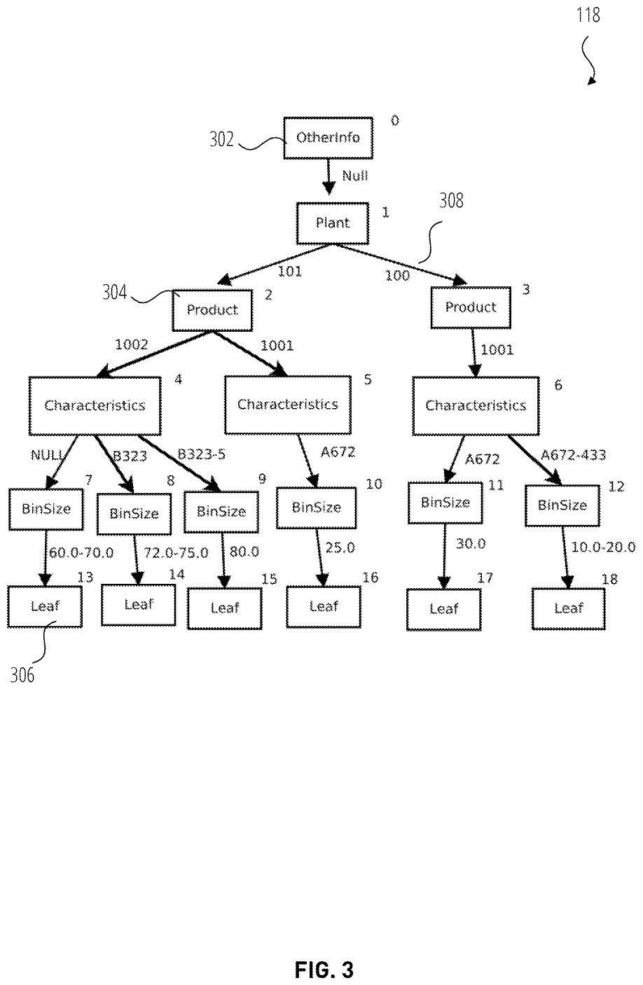

The decision tree data structure 118 refers to a particular data structure created by the computer 102, particularly, the program 114 to transform and store the data in the records 126 to a particular format to facilitate an improved data traversal. The data traversal using the decision tree data structure 118 facilitates addressing the technical challenges described with validating and predicting attribute values. In computer science, the term “decision tree” refers to a type of tree-based learning algorithm, including, but not limited to, model trees, classification trees, and regression trees. As noted, the decision tree data structure 118 described herein differs from the result of conventional decision tree algorithms because of the absence of target attributes, which are used by the conventional decision trees. FIG. 3 depicts an example decision tree data structure 118.

The decision tree builder 120 facilitates constructing the decision tree data structure 118 using the records 126 from the database 104. The decision tree builder 120 computes one or more parameters, such as an entropy, a weight, or any other operational parameter, while generating nodes and/or paths in the decision tree data structure 118. The decision tree builder 120 can be a separate module or part of the computer program 114. The decision tree builder 120 may or may not be directly accessible by the user 124. In some embodiments, one or more actions by the user 124 via the user-interface 116 invokes the decision tree builder 120 to perform one or more actions in response. In some embodiments, the processor circuit 106 executes one or more instructions from the decision tree builder 120 to perform the one or more actions in response. In some embodiments, the decision tree builder 120 is executed independently, via a separate user-interface (not shown) distinct from the user-interface 116. In this manner, the decision tree data structure 118 is constructed and ready to be used when the user 124 accesses the program 114 via the user-interface 116.

The decision tree traverser 122 facilitates traversing one or more paths through the decision tree data structure 118. The decision tree traverser 122, in some embodiments, computes one or more parameters, such as a weight, or any other operational parameter, while traversing (or by traversing) a path in the decision tree data structure. The decision tree traverser 122 can be a separate module or part of a computer program executable by the computer 102. The decision tree traverser 122 may or may not be directly accessible to the user 124. In some embodiments, one or more actions by the user 124 via the user-interface 116 invokes the decision tree traverser 122 to perform one or more actions in response. In some embodiments, the processor circuit 106 executes one or more instructions from the decision tree traverser 122 to the one or more actions in response.

FIG. 2 depicts an example of a user-interface 116 for completing an example record 126 according to one or more embodiments. The examples of the user-interface 116 and the record 126 are based on an example dataset 202. It is understood that the dataset 202 is just an example for explanation, and that in one or more embodiments of the technical solutions described herein, the dataset 202 can include a much larger number of rows and columns. Further, although the dataset 202 is depicted in a tabular format, the dataset 202 may be stored using any other format, depending on efficiency of data storage, data retrieval, or any other considerations of system efficiency.

In context of the depicted dataset 202, each row of the dataset 202 represents an individual record 126, and each column of the dataset 202 represents an attribute of the record 126. Thus, in the depicted dataset 202, each record 126 includes five attributes-product, plant, bin size, characteristics, and other info. It is understood that this list of attributes is one possible example, and that in other embodiments, the record 126 can include different, fewer, or additional attributes. Further, it is understood that although the dataset 202 is shown to include only 10 records 126, in other embodiments, the dataset 202 can include different, fewer, or additional records 126.

Each attribute can be set or assigned a value. For example, in the illustration, the first record 126 in the dataset 202 shows values assigned to the attributes as product-1001; plant-100; bin size-10.0; characteristics A672; and other info-<blank>. It is understood that in other embodiments, different values may be assigned to the attributes. The value assigned to an attribute depends on an attribute type assigned to the attribute. Each attribute has a predetermined attribute type, which is indicative of a data type of the value that can be assigned to that attribute. For example, attribute types can include integer, floating point, character, or any other data type supported by the database 104. In the example dataset 202, consider that Product, Plant, BinSize, Characteristics, and OtherInfo are attributes of data types integer, integer, float, character, and character respectively.

Continuing reference to FIG. 2, the record 126 can be represented in the user-interface 116 in a graphical form. It is understood that the user-interface 116 that is depicted is just an example, and that the arrangement of the shown elements can be varied without affecting aspects of the technical solutions described herein. In the depicted user-interface 116, a form 204 is shown. The form 204 includes user-interface elements 206. The user-interface elements 206 facilitate the user 124 to view labels representative of the attributes and enter corresponding attribute values that the user 124 desires to assign to each of the attributes. The user-interface elements 206 can be of any type, such as labels, text boxes, lists, tables, etc., and do not limit aspects of the technical solutions described herein. The user 124 can view one or more records 126 via the user-interface 116 in some embodiments. Alternatively, or in addition, the user 124 can add or change values of one or more attributes of the record 126 displayed via the user-interface 116.

As the user 124 inputs values for one or more attributes via the user-interface 116, the system 100 facilitates predicting values for the remaining attributes. The predicted values are determined based on the decision tree data structure 118. In some embodiments, the prediction is performed using machine learning (ML) based on the decision tree data structure 118. In some embodiments, the prediction is performed in real time. The predicted values may be displayed via the user-interface 116 in the user-interface elements, for example. Alternatively, or in addition, the predicted values may be displayed in a separate user-interface element, such as a sidebar, a pop-up, etc.

In some embodiments, the system 100 validates the values as the user 124 enters them. The validation can include checking that the value entered for an attribute is acceptable for that attribute. For example, if the user 124 enters an erroneous value for an attribute, the system 100 displays a notification indicative that the value is invalid and would need to be updated accordingly. The notification may include an audiovisual notification. The notification may specify the attribute that needs to be corrected.

FIG. 3 depicts an example decision tree data structure 118 according to one or more embodiments. The decision tree data structure 118 represents the dataset 202 illustrated in FIG. 2, and as such, in other embodiments, the decision tree data structure 118 can be different from the illustration depending on the dataset 202 in those embodiments.

The decision tree data structure 118 includes nodes 304 and edges 308. The nodes 304 include a root node 302, which has no incoming edges 308. The nodes 304 also include one or more leaf nodes 306, which do not have any outgoing edges 308. Apart from the root node 302 and the leaf nodes 306, the remaining nodes 304 have both, incoming and outgoing edges 308. Unless explicitly specified otherwise, a “node” herein can refer to any of the root node 302, nodes 304, and leaf nodes 306. In some embodiments, each node 304 has a maximum of two outgoing edges 308 and one incoming edge 308. In other embodiments, the nodes 304 have no restrictions about the number of incoming or outgoing edges 308. In some embodiments, the number of incoming edges is always one and the number of outgoing edges can be one or more.

Each node 304 is assigned an ordinal number, which can be a unique identifier of the node. In some embodiments, the ordinal number can be determined based on a sequence in which the nodes 304 are added to the decision tree data structure 118 during its construction. For example, in the illustrated decision tree data structure 118, the root node 302 is OtherInfo with ordinal number 0, followed by the node 304 Plant with ordinal number 1. There are two Product nodes 304 with ordinal numbers 2 and 3; three Characteristics nodes 304 with ordinal numbers 4-6; and six BinSize nodes 304 with ordinal numbers 7-12. Leaf nodes 306 13-18 follow. During the tree construction, each node can be assigned one or more properties in addition to the ordinal number, as is described elsewhere herein.

An edge 308 connects a pair of nodes 304. An edge 308 can be identified by the pair of nodes 304 that the edge 308 connects. A path between two nodes 304, a start node and an end node, is a collection of edges 308 from the start node to the end node through one or more intermediate nodes 304. Each edge 308 can also have one or more properties associated with it in one or more embodiments.

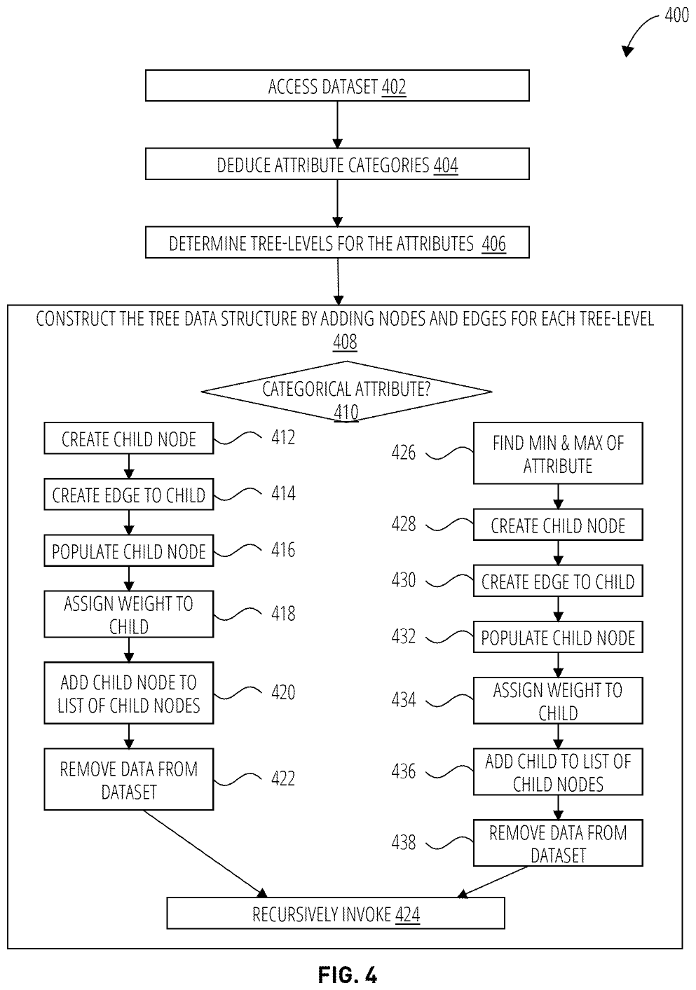

FIG. 4 illustrates an example method 400 for constructing a decision tree data structure 118 from the records 126 stored in a dataset 202 according to one or more embodiments. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence. The method 400 can be implemented as one or more computer executable instructions, hardware module, or a combination thereof. The decision tree builder 120 executes the method 400 in some embodiments.

According to some examples, the method 400 includes accessing the dataset 202. In some embodiments, the dataset 202 to be used to construct, build, or generate the decision tree data structure 118 is provided by a user 124, such as an administrator. The dataset 202 is provided can be provided as an input via an API in some embodiments. In some embodiments, only a subset of the dataset 202 is provided as an input to construct the decision tree data structure 118. The user 124 can indicate the subset of records 126 from the dataset 202 that are to be used to construct the decision tree data structure 118.

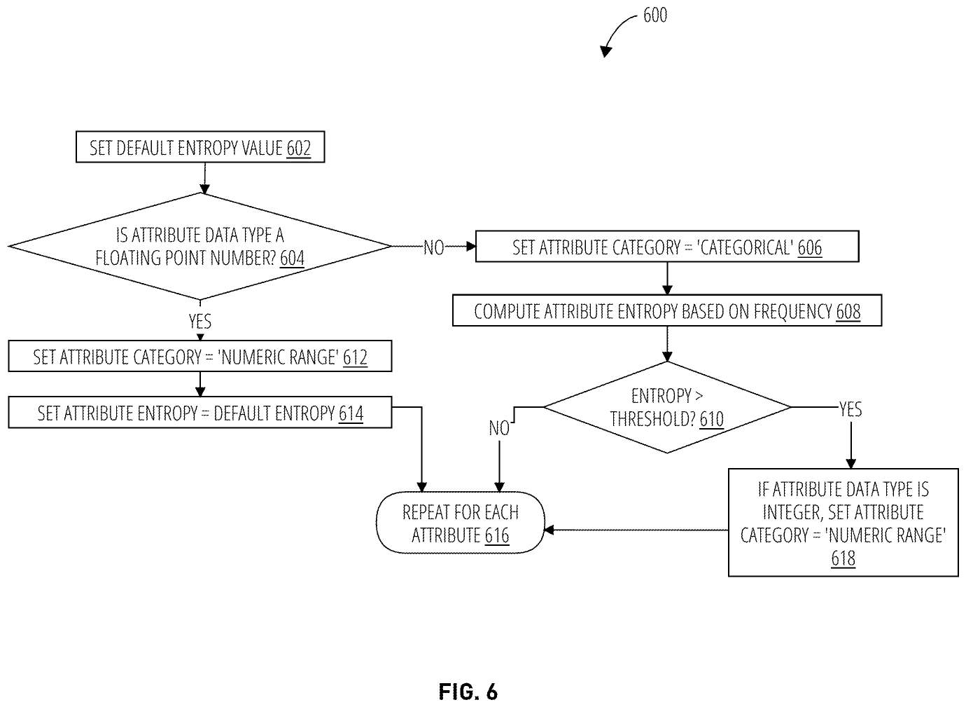

The method 400 further includes deducing attribute categories at block 404. The decision tree builder 120 analyzes the attributes of the records 126 in the dataset 202 to identify a category of each attribute. In some embodiments, the decision tree builder 120 categorizes whether each attribute is categorical or numeric range. Based on the attribute type and/or a value assigned to it, an attribute can be categorized. For example, attribute categories can include numeric range, categorical, etc. In some embodiments, an attribute of category “numeric range” indicates that its value is to be processed as a numeric value; whereas an attribute of category “categorical” indicates that its value is to be processed as a category (even if the stored value is a number). FIG. 6 and corresponding description discusses deducing the attribute categories in further details.

Consider the example dataset 202 from FIG. 2, and an example scenario in which the default or base entropy for each attribute is set to a value of 3.32. Other default entropy values can be used in other embodiments. The result of the attribute deduction techniques described herein, can result in the attributes of the dataset 202 being assigned the following values.

TABLE 1

| Attribute | Entropy | Category |
|---|---|---|
| Product | 1.0 | Categorical |
| Plant | 0.88 | Categorical |
| Bin Size | 3.32 | Numerical Range |
| Characteristics | 2.25 | Categorical |
| OtherInfo | 0.0 | Categorical |

In the example dataset 202, as shown in Table 1, all attributes other than BinSize are marked as ‘categorical’ and BinSize is marked as ‘numeric range.’

The method 400 further includes determining tree-levels for the attributes at block 406. A tree-level is assigned to each attribute. In some embodiments, the tree-levels are assigned based on the entropy values. For example, the attributes are sorted with entropy value as key, and the tree-levels are assigned to the attributes based on the sorted order. For example, for the ongoing example, the sorted order, and thus, the tree-levels for the attributes from the dataset 202 are as per Table 2. As can be seen the attributes are sorted in an ascending order of their entropy values.

TABLE 2

| Attribute | Entropy | Tree-level |
|---|---|---|
| OtherInfo | 0.0 | 0 |
| Plant | 0.88 | 1 |
| Product | 1.0 | 2 |
| Characteristics | 2.25 | 3 |
| BinSize | 3.32 | 4 |

According to some examples, the method includes constructing the tree data structure by adding nodes and edges at block 408. At this point, the decision tree data structure 118 is constructed by creating data structures for the nodes 304 and edges 308 and interconnecting such data structures. It should be noted that the data structures used to represent the nodes 304 and the edges 308 can vary according to the programming language or style used to implement the technical solutions described herein.

Each node 304 is assigned a unique ordinal number. The ordinal number starts from 0 in embodiments described herein. The numbering can vary in other embodiments. Similarly, a unique ordinal number (starting from 0) is assigned to each edge 308. The numbering used for the edges 308 can also vary in other embodiments. Additionally, in some embodiments, the following information from Table 3 is kept in each node. The information can also be referred to as properties of the nodes 304.

TABLE 3
Node Properties

Parent node number (for root node, the parent is set as −1)
Incident edge number (for root node, this is set to −1)
Children node numbers accessible via hashed edge value
Node weight

The node properties are used while constructing and traversing the decision tree data structure 118. For each tree-level, which reflects the number of attributes in the dataset 202, one or more nodes 304 are created and added, and further edges 308 are created and added between certain pairs of nodes 304 to construct the decision tree data structure 118. Once constructed, the decision tree data structure 118 is stored in the computer 102.

Creating the decision tree data structure 118 starts with the original input data (i.e., dataset 202 or a subset thereof), a tree-level number of 0, and a node number of 0. At each tree-level, the following steps are invoked recursively with a subset of the original input data, next tree-level number, and the node number for which a subtree is to be created. The steps for adding the nodes 304 and the edges 308 are also provided in the form of pseudo code in Table 4.

Referring to the flowchart, the operations for adding nodes 304 and edges 308 for a tree-level start by selecting the attribute assigned the tree-level being populated. For example, initially, for the tree-level 0, the OtherInfo attribute is selected. The root node 302, which is a special node, is initialized and selected as the first node from which the following steps progress. Thus, initially the decision tree data structure 118 is created to only include the root node 302 at tree-level 0, and no edges 308. As the tree construction progresses, attributes are selected, the root node 302 is populated, additional nodes 304 are added and populated at the corresponding tree-levels, and edges are added between parent and child nodes. Here, “populating” a node 304 represents adding the information or assigning properties to each node 304.

At decision block 410, the attribute category of the selected attribute is checked. If the attribute is categorical, a child node 304 is created at block 412. Creating a child node 304 includes creating a data structure being used for a node 304. In other words, a memory buffer is allocated to store the child node 304.

Further, at block 414, an edge 308 is created. Creating an edge 308 includes allocating a memory buffer to store a data structure used to represent an edge 308. The edge 308 stores a value of the attribute for which the child node is created (in block 412).

At block 416, the child node 304 is populated. The parent node's ordinal number and the incident edge's ordinal number are stored in the child node 304. Further, at block 418 a weight is assigned to the child node 304. In some embodiments, the weight is the number of rows in the dataset 202. As discussed further, the number of rows changes as the tree is constructed. The child node 304 is added to a list of child nodes of the present node 304 at block 420.

At block 422, a new dataset is created by removing one or more attributes from the original input dataset 202. Creating the new dataset includes creating, a subset of the records 126 from the input data by selecting the records 126 that match the distinct value of the attribute for which the child node 304 is created. Further, a subset of columns is created by removing the attribute column from this subset of record 126. The remaining subset of columns represents the new dataset, which is now used as the input dataset for recursive invocation of the algorithm for adding nodes 304 and edges 308 to the decision tree data structure 118.

Accordingly, at block 424, the algorithm is recursively invoked with the created new dataset (subset of columns from the rows) for the next tree-level (e.g., present tree-level incremented by 1).

Alternatively, if at decision block 410, the category of the attribute is numeric range (and not categorical), at block 426, the minimum and maximum values of the attribute are determined from the input dataset. A child node 304 is created for the attribute at block 428. Further, an edge 308 is created for the child node 304 at block 430. The edge 308 is assigned the min-max range of the attribute value (from block 426).

The child node 304 is populated at block 432. The parent node's ordinal number and the incident edge's ordinal number are stored in the child node 304. Further, a weight is assigned to the child node 304 at block 434. In some embodiments, the weight is the number of rows in the dataset 202. As discussed further, the number of rows changes as the tree is constructed. The child node 304 is added to a list of child nodes of the present node 304 at block 436.

At block 438, a new dataset is created by removing one or more attributes from the input dataset. Creating the new dataset includes creating, a subset of the records 126 from the input data by selecting the records 126 that match the distinct value of the attribute for which the child node 304 is created. Further, a subset of columns is created by removing the attribute column from this subset of record 126. The remaining subset of columns represents the new dataset, which is now used as the input dataset for recursive invocation of the algorithm for adding nodes 304 and edges 308 to the decision tree data structure 118. At block 424, the algorithm is recursively invoked with the created new dataset (subset of columns from the rows) for the next tree-level (e.g., present tree-level incremented by 1).

TABLE 4
Pseudo Code For Adding Nodes and Edges To Each Tree-level

```
pick the attribute with the level number passed in
if the attribute category is categorical
  for each distinct value
    create a child node
    create an edge to the child node corresponding to the value
    populate the child node with parent number, incident edge number
    assign the weight to the child as the number of rows of input data
    add the child to this node's children
    create a subset of the rows by selecting rows that match the distinct value in the
attribute
    create a subset of columns by removing the attribute column from this subset of rows
    recursively invoke the algorithm by passing this subset of rows and columns and the
level number incremented by 1
else
  find min and max values of the attribute column
  create a child node
  create an edge corresponding the min and max values
  populate the child node with parent number, incident edge number
  assign the weight to the child as the number of rows of input data
  add this child to this node's children
  create a subset of columns by removing the attribute column from this subset of rows
  recursively invoke the algorithm by passing this subset of rows and columns and the level
number incremented by 1
```

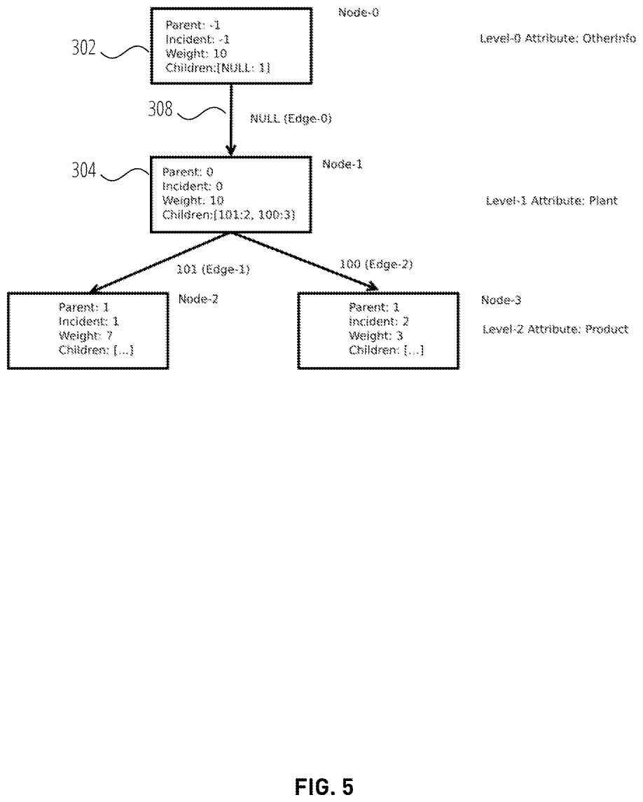

FIG. 5 depicts the state of the partial decision tree data structure 118 after level 0 and level 1 nodes 304 were fully created and level 2 nodes are in the process of being created. FIG. 3 depicts the decision tree data structure 118 representing the entire dataset 202 as per the example herein. In FIG. 3, only the nodes 304 and edges 308 are shown. Other details, such as node properties and edge values are left out for brevity.

In the tree building algorithm discussed herein, an attribute with the next lowest entropy value is chosen to branch on at each tree-level, which facilitates an improved decision tree data structure 118 for the prediction and validation of attributes according to embodiments herein. Conventionally, an attribute to branch on is chosen arbitrarily. For example, in the ongoing scenario with dataset 202, a valid decision tree can be constructed where the attribute OtherInfo is chosen at level 3 instead of level 0 (as described herein). However, the resulting decision tree data structure 118 has more internal nodes 304 than the one built earlier (FIG. 3). By choosing the attribute with the minimum entropy earlier technical solutions described herein reduce the number of internal nodes 304. Moreover, if the decision tree builder 120 had recomputed the entropy at each tree-level on the subset of the rows processed, the decision tree builder 120 would have arrived at a different decision tree data structure 118, which is still optimized in terms of number of internal nodes 304. However, indexing and tree traversal for prediction will be more complicated (as described further). For such reasons, computing the entropies only once in the beginning and assigning tree-levels for each attribute statically results in an optimized decision tree decision tree data structure 118 for the prediction and validation.

FIG. 6 depicts a flowchart of a method 600 for deducing a category of an attribute of the records 126 from the dataset 202 according to one or more embodiments. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

Based on the attribute type and/or a value assigned to it, an attribute can be categorized. For example, attribute categories can include numeric range, categorical, etc. In some embodiments, an attribute of category “numeric range” indicates that its value is to be processed as a numeric value; whereas an attribute of category “categorical” indicates that its value is to be processed as a category (even if the stored value is a number). For example, in the example dataset 202, the attribute bin size may be categorized as “numeric range,” whereas the product attribute may be categorized as “categorical.”

According to some examples, the method includes setting default entropy value for each attribute at block 602. In computer or information science, “entropy” refers to a quantity and the expected value for a level of self-information. In general, entropy is a non-negative number, with larger values indicating greater uncertainty. If all outcomes are equally likely, the entropy is at its maximum, and if only one outcome is possible, the entropy is zero.

Further, for each attribute, the method 600 includes checking the data type of the attribute at decision block 604. If the data type is a floating-point number, the attribute category is set to ‘numeric range’ at block 612, and the attribute entropy is set to the default entropy at block 614.

If the data type is not a floating-point number, the attribute category is set to ‘categorical’ at block 606. Further, the method includes computing attribute entropy based on frequency counts of distinct values of the attribute in the records 126 at block 608. The entropy value for the attribute is computed using techniques, such as using Shannon's Formula. The Shannon entropy is a measure of the uncertainty or randomness in a set of outcomes. It can be expressed mathematically as: H=−ΣPᵢ log₂(Pᵢ), where H is the entropy, Pᵢ is the probability of the i-th outcome, and the summation is taken over all possible outcomes. Entropy for the attribute can be computed as H=ΣPᵢ log₂(1/Pᵢ). In other embodiments, the default entropy value can be computed using other techniques.

Further, the method 600 includes checking if the computed entropy exceeds a threshold at decision block 610. The threshold can be a static value or a dynamic value. For example, the threshold can be a percentage of the default entropy value. If the computed entropy value of the attribute exceeds the threshold, and if the attribute's data type is integer, the attribute category is set to ‘numeric range’ at block 618. A user can set the threshold, for example, 90% of default entropy.

In some embodiments, the user 124 can override the attribute categories based on the user's domain knowledge before next step is performed. The user-interface 116 can facilitate the user 124 to provide his/her input during this process. When the category of an attribute of float type is changed from ‘numeric range’ to categorical, the entropy of that attribute is recomputed in some embodiments.

The above operations are repeated for each attribute of the record 126 from the dataset 202 until the deduction of attribute categories is completed at block 516. The attribute category deduction is used to construct the decision tree data structure 118 in some embodiments. Table 1 provides pseudo code for deducing the attribute category according to one or more embodiments. It is understood that in other embodiments, the attribute categories can be deduced using a different pseudo code or instructions.

TABLE 5
Pseudo Code For Deducing Attribute
Categories and Entropy Values

```
set base entropy to log₂N where N is the number of records
for each attribute
  if attribute type is float
  set attribute category as ‘numeric range’
  set entropy as the base entropy
  else
  compute entropy based on frequency counts of distinct values
  set attribute category as ‘categorical’
  if entropy is above a percentage of base entropy
    if attribute is integer
      set attribute category as ‘numeric range’
```

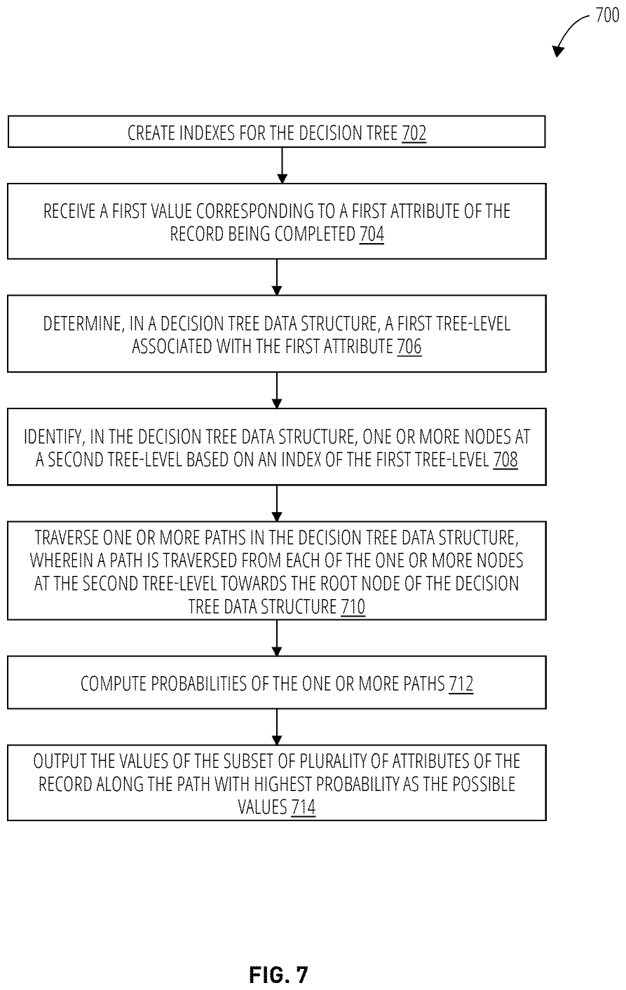

FIG. 7 illustrates an example method 700 for using the decision tree data structure 118 for prediction of attribute values and for validation of attribute values according to one or more embodiments. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence. The decision tree traverser 122 can implement the method 700 in one or more embodiments.

Consider that the user 124 is entering or inputting one or more records 126, i.e., entering or editing values of one or more attributes of a record 126. The user 124 can input such attribute values via the user-interface 116.

The method 700 includes creating indexes for the decision tree data structure 118 at block 702. At each tree-level, for each edge 308 given that edge's value the nodes 304 that the edge 308 points to are indexed. In the ongoing example, the indexes built will be as follows:

| Tree-level | Edge Indexes |
|---|---|
| 0 | NULL: [1] |
| 1 | 101: [2], 100: [3] |
| 2 | 1002: [4], 1001: [5, 6] |
| 3 | NULL: [7], B323: [8], B323-5: [9], |
| | A672: [10, 11], A672-433: [12] |
| 4 | 60.0-70.0: [13], 55.0-75.0: [14], 65.0: [15], |
| | 25.0: [16], 30.0: [17], 10.0-20.0: [18] |

In some embodiments, the indexes can be built while constructing the decision tree data structure 118 itself. The index of a (first) tree-level provides a mapping between a value of an attribute at that tree-level and the nodes from another (second) tree-level based on historical records used to generate the decision tree data structure 118. The decision tree traverser 122 uses the indexes to locate a start node faster, and thus, in an improved manner than by performing a sequential search.

Referring to the method 700, at block 704, a first value corresponding to a first attribute of the record 126 being completed is received from the user 124, via the user-interface 116. Consider that the user inputs Characteristics: A672 (first attribute-first value), and that we want to predict values that the attribute Plant can take.

According to some examples, the method includes determining, by the processor, in a decision tree data structure, a first tree-level associated with the first attribute, wherein the decision tree data structure comprises a plurality of tree-levels corresponding to the plurality of attributes, respectively at block 706.

The method 700 includes identifying, in the decision tree data structure 118, one or more nodes 304 at a second tree-level based on an index of the first tree-level, wherein the index of the first tree-level comprises a mapping between the first value of the first attribute and the one or more nodes 304 from the second tree-level based on historical records used to generate the decision tree data structure 118 at block 708.

Further, the method 700 includes traversing one or more paths in the decision tree data structure 118, wherein a path is traversed from each of the one or more nodes 304 at the second tree-level towards the root node 302 of the decision tree data structure 118 at block 710.

Consider the ongoing example. The first attribute Characteristics is at tree-level 3. Using the indexes, it is determined that nodes 10, and 11 have edges 308 with value A672 pointing to them. Starting from 10 and 11 the decision tree data structure 118 is traversed up until the Plant node 304 is reached. We end up with the following paths traced:

Characteristics: A672, Product: 1001, Plant: 101
Characteristics: A672, Product: 1001, Plant: 100

According to some examples, the method includes computing probabilities of the one or more paths at block 712. The probability of a path is determined by the weight of the path. In the example, both paths have a weight of 1 which is the weight of the highest-level node (Characteristics) in the two paths. Thus, there is equal probability for both paths. Because in this example the value of Product is not the target predicted value, the result will be:

Plant: 101 with probability 0.5
Plant: 100 with probability 0.5

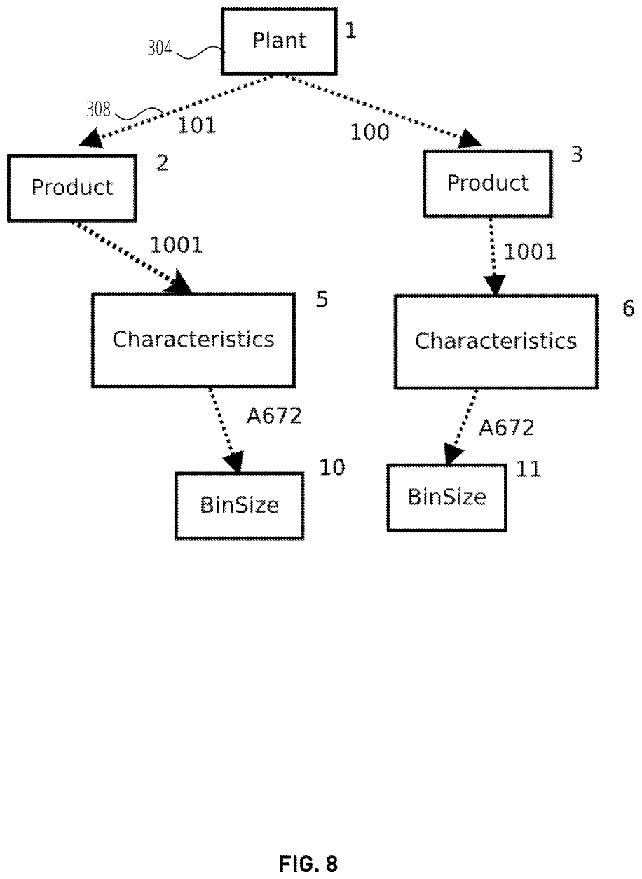

FIG. 8 shows a partial decision tree data structure 118 with the paths in the above example traced in dotted lines. Note that the paths are traced by the decision tree traverser 122 along opposite direction of arrowheads shown.

Another example scenario is now discussed where the decision tree data structure 118 is traversed in both directions, up and down the tree as well. The same dataset 202 and the corresponding decision tree data structure 118 are used in this example. Assume the following values are known, i.e., entered by the user 124: OtherInfo: NULL, Product: 1002, and that the system 100 is predicting values for the attribute BinSize (target attribute).

In this case, the decision tree traverser 122 traverses the decision tree data structure 118 both up and down. The decision tree traverser 122 starts with the highest-level node 304 from the given data. In this example, OtherInfo is at tree-level 0 and Product is at tree-level 2. So, the decision tree traverser 122 starts with Product and traverses up until the value of OtherInfo is covered as NULL. Further, the decision tree traverser 122 traverses down the decision tree data structure 118 until the BinSize nodes 304 are reached and all outgoing edges 308 with their weights are identified. The resulting paths and weights are shown below:

OtherInfo: NULL, Product: 1002, BinSize: 60.0-70.0 weight: 2
OtherInfo: NULL, Product: 1002, BinSize: 72.0-75.0 weight: 2
OtherInfo: NULL, Product: 1002, BinSize: 80.0 weight: 1

In terms of probabilities, this translates to:

OtherInfo: NULL, Product: 1002, BinSize: 60.0-70.0 with probability: 0.4
OtherInfo: NULL, Product: 1002, BinSize: 72.0-75.0 with probability: 0.4
OtherInfo: NULL, Product: 1002, BinSize: 80.0 with probability: 0.2

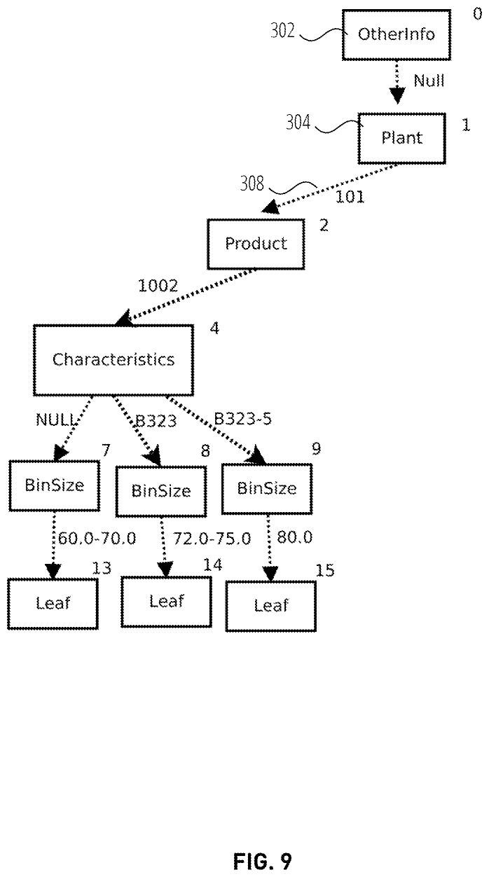

FIG. 9 depicts the partial tree with paths traversed in dotted lines. The operations performed by the decision tree traverser 122 to traverse the decision tree data structure 118 to determine the predicted values can be summarized by the pseudo code in Table 6.

TABLE 6
Pseudo Code for tree traversal for prediction

```
get the highest level attribute in the given data
  from indexes get the nodes for this attribute value
for each node
    traverse up the tree to trace a path until all given attributes and attributes to predict are
covered
  if there is any attribute to predict is not covered
    traverse down the tree until all attributes to predict are covered
save the path and the weight of the highest level attribute in the path
```

The method 700 further includes outputting the values of the subset of plurality of attributes of the record 126 along the path with highest probability as the possible values, i.e., predicted values, at block 714. The predicted values are output in the user-interface into the one or more fields in the form 204 in some embodiments. The predicted values can be presented in any other manner in other embodiments.

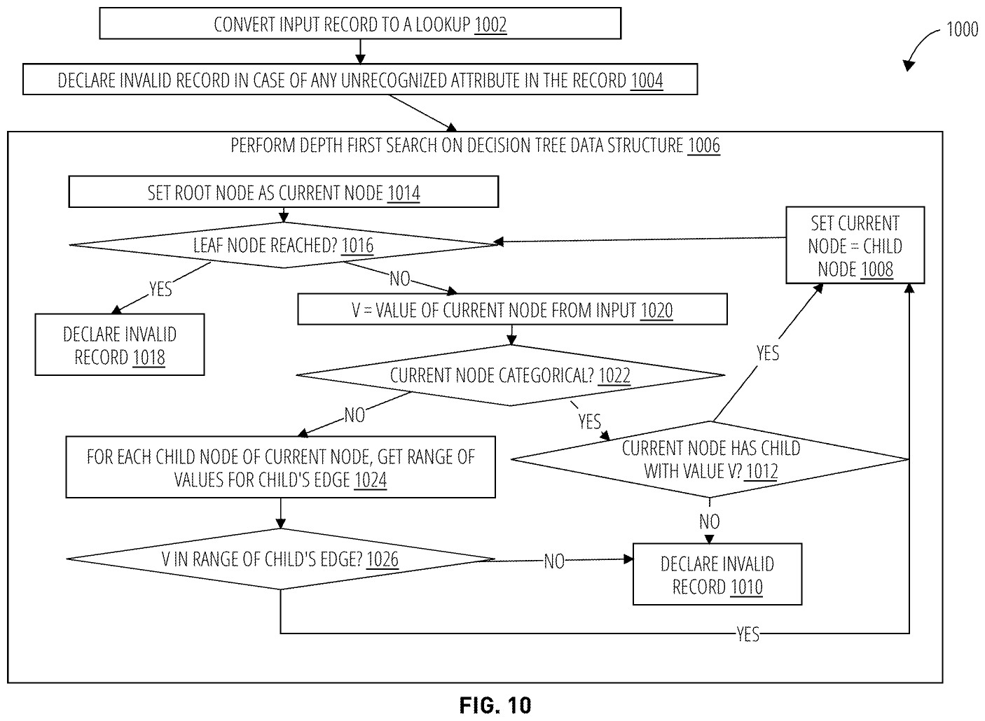

In some embodiments, the method 700 further includes validating the input record 126 provided by the user 124. The validation is performed using the decision tree data structure 118. Validation of the record 126 that is input is described herein. (See FIG. 10).

FIG. 10 illustrates an example method 1000 for validation of an input record according to one or more embodiments. Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence.

According to some examples, the method 1000 includes converting an input to a lookup at block 1002. The “lookup” comprises a data structure with the same structure as the record 126. For example, consider that the user 124 provides, via the user-interface 116, or in any other manner, the input values: Product: 1002; Plant: 101; BinSize: 65.0; Characteristics: B323; and OtherInfo: NULL. The input data from the user 124 is converted into a record 126 that is to be validated. The converted record 126 is then validated.

According to some examples, the method 1000 includes declaring the record 126 as an invalid record in case of any unrecognized attribute in the record 126 at block 1004. For example, if the user 124 had provided a field such as Customer-Id: 79, the record 126 would be declared invalid.

According to some examples, the method 1000 further includes performing a depth first search on the decision tree data structure 118 using the values provided by the user 124 in the record 126 at block 1006. The depth first search for the validation is described further. The depth first search is also expressed as pseudo code in Table 7.

For the depth first search, according to some examples, the method 1000 includes setting root node 302 of the decision tree data structure 118 as current node at block 1014. The decision tree data structure 118 is pre-constructed by the decision tree builder 120 as described herein using historical records 126 from the dataset 202.

The method 1000 further includes setting v=value of current node from input record 126 at block 1020. It is checked if the attribute type of the current node is categorical at decision block 1022.

If the attribute type is categorical, it is checked if the current node has a child node with value v at decision block 1012. If the current node does not have a child node with value v, the record 126 input by the user 124 is declared invalid at block 1010. Alternatively, if the current node has a child node with value v, the current node is updated and the child node is set as the current node being traversed at block 1008.

If, at decision block 1022, the attribute type is not categorical (i.e., it is numerical), for each child node of current node, corresponding range of values for the child's edge is obtained at block 1024. The method 1000 further includes checking if v is in any one of the ranges of children nodes' edges at decision block 1026. If v is in the range of an edge to child node X, the current node is updated, and the child node X is set as the current node being traversed at block 1008. If v is not in any of the ranges of children nodes' edges at decision block 1026, the input record 126 is declared as invalid at block 1010.

If the current node, which is updated during the method is not a leaf node 306 of the decision tree data structure 118, the method 1000 is reiterated as described herein at decision block 1016. Alternatively, if the current node is a leaf node 306, the input record 126 is declared to be invalid at block 1018.

In some embodiments, the method 1000 includes notifying the user 124 whether the record 126 is valid or invalid. The notification can be provided via the user-interface 116. The notification can be an audiovisual notification, such as a pop-up window, a highlight, an audible, etc. In some embodiments, the attribute of the input record 126 that is particularly identified as invalid can be highlighted for the user 124 to correct/edit. Upon receiving an updated input from the user 124, the validation can be performed again.

In some embodiments, the record 126 can be added to the dataset 202 upon successful validation (i.e., record 126 being valid). If the record 126 is deemed to be invalid, the dataset 202 is not updated to include the record 126.

While various embodiments have been described above, it should be understood that they have been presented by way of example only, and not limitation. Where methods and/or schematics described above indicate certain events and/or flow patterns occurring in certain order, the ordering of certain events and/or flow patterns may be modified. While the embodiments have been particularly shown and described, it will be understood that various changes in form and details may be made. Additionally, certain of the steps may be performed concurrently in a parallel process, when possible, as well as performed sequentially as described above. Although various embodiments have been described as having particular features and/or combinations of components, other embodiments are possible having any combination or sub-combination of any features and/or components from any of the embodiments described herein. Furthermore, although various embodiments are described as having a particular entity associated with a particular compute device, in other embodiments different entities can be associated with other and/or different compute devices.

It is intended that the systems and methods described herein can be performed by software (stored in memory and/or executed on hardware), hardware, or a combination thereof. Hardware modules may include, for example, a general-purpose processor, a field programmable gates array (FPGA), and/or an application specific integrated circuit (ASIC). Software modules (executed on hardware) can be expressed in a variety of software languages (e.g., computer code), including Unix utilities, C, C++, Java™, JavaScript, Ruby, SQL, SAS®, the R programming language/software environment, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code. Each of the devices described herein can include one or more processors as described above.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

While one or more embodiments of the technical solutions have been described in detail, variations in fashioning and implementing the systems and methods described herein will be apparent to those of skill in the art, without departing from the scope and spirit of the invention, as defined in the following claims.

What is claimed is:

1. A computer-implemented method to predict possible values for a subset of a plurality of attributes of a record when the record is being interactively completed, the computer-implemented method comprising:
receiving, by a processor, via a user-interface, a first value corresponding to a first attribute of the record being completed;
determining, by the processor, in a decision tree data structure, a first tree-level associated with the first attribute, the decision tree data structure comprising a plurality of tree-levels corresponding to the plurality of attributes, respectively;
identifying, by the processor, in the decision tree data structure, one or more nodes at a second tree-level based on an index of the first tree-level, wherein the index of the first tree-level comprises a mapping between the first value of the first attribute and the one or more nodes from the second tree-level based on historical records used to generate the decision tree data structure;
traversing, by the processor, one or more paths in the decision tree data structure, wherein a path is traversed from each of the one or more nodes at the second tree-level towards a root node of the decision tree data structure;
computing, by the processor, probabilities of the one or more paths; and
outputting, by the processor, the values of the subset of plurality of attributes of the record along the path with highest probability as the possible values.

2. The computer-implemented method of claim 1, wherein the first value comprises two or more values corresponding to two or more attributes of the record.

3. The computer-implemented method of claim 2, wherein the first attribute is selected from the two or more attributes as an attribute with a corresponding node in the decision tree data structure with a highest weight among weights assigned to nodes corresponding to the two or more attributes.

4. The computer-implemented method of claim 1, wherein the second tree-level is lower in the decision tree data structure relative to the first tree-level.

5. The computer-implemented method of claim 1, wherein the path is traversed from the one or more nodes at the second tree-level towards the root node of the decision tree data structure until a target tree-level corresponding to a target attribute is reached.

6. The computer-implemented method of claim 5, wherein the target attribute is a first target attribute, the target tree-level is a first target tree-level, and the method further comprises, in response to an attribute from the subset of the plurality of attributes not yet having a predicted value, traversing the path downwards from the first target tree-level to a second target tree-level corresponding to a second attribute from the subset of the plurality of attributes.

7. The computer-implemented method of claim 6, further comprising, validating, by the processor, the record based on the decision tree data structure in response to the record completed via the user-interface.

8. The computer-implemented method of claim 1, wherein the decision tree data structure is generated using machine learning based on historical records.

9. The computer-implemented method of claim 1, wherein generating the decision tree data structure comprises, for each attribute in the record, determining an attribute type and computing an entropy based on the attribute type.

10. The computer-implemented method of claim 9, wherein generating the decision tree data structure further comprises assigning tree-levels to each attribute based on a sorted order of the entropies.

11. The computer-implemented method of claim 10, wherein generating the decision tree data structure further comprises, for each tree-level, invoking a sub-tree generating algorithm for each node in the tree-level.

12. A computing apparatus comprising:
a processor; and
a memory storing instructions that, when executed by the processor, configure the apparatus to predict possible values for a subset of a plurality of attributes of a record when the record is being interactively being completed:
receive a first value corresponding to a first attribute of the record being completed;
determine, in a decision tree data structure, a first tree-level associated with the first attribute, the decision tree data structure comprising a plurality of tree-levels corresponding to the plurality of attributes, respectively;
identify, in the decision tree data structure, one or more nodes at a second tree-level based on an index of the first tree-level, wherein the index of the first tree-level comprises a mapping between the first value of the first attribute and the one or more nodes from the second tree-level based on historical records used to generate the decision tree data structure;
traverse, one or more paths in the decision tree data structure, wherein a path is traversed from each of the one or more nodes at the second tree-level towards a root node of the decision tree data structure;
compute probabilities of the one or more paths; and
output values of the subset of plurality of attributes of the record along the path with highest probability as the possible values.

13. The computing apparatus of claim 12, wherein the first value comprises two or more values corresponding to two or more attributes of the record.

14. The computing apparatus of claim 13, wherein the first attribute is selected from the two or more attributes as an attribute with a corresponding node in the decision tree data structure with a highest weight among weights assigned to nodes corresponding to the two or more attributes.

15. The computing apparatus of claim 13, wherein the instructions further configure the apparatus to, validate, by the processor, the record based on the decision tree data structure in response to the record completed via a user-interface.

16. The computing apparatus of claim 13, wherein generating the decision tree data structure comprises:
for each attribute in the record, determining an attribute type and computing an entropy based on the attribute type;
assigning tree-levels to each attribute based on a sorted order of the entropies; and
for each tree-level, invoking a sub-tree generating algorithm for each node in the tree-level.

17. A non-transitory computer-readable storage medium, the computer-readable storage medium including instructions that when executed by a computer, cause the computer to:
receive via a user-interface, a first value corresponding to a first attribute of a record being completed;
determine in a decision tree data structure, a first tree-level associated with the first attribute, wherein the decision tree data structure comprises a plurality of tree-levels corresponding to the plurality of attributes, respectively;
identify in the decision tree data structure, one or more nodes at a second tree-level based on an index of the first tree-level, wherein the index of the first tree-level comprises a mapping between the first value of the first attribute and the one or more nodes from the second tree-level based on historical records used to generate the decision tree data structure;
traverse one or more paths in the decision tree data structure, wherein a path is traversed from each of the one or more nodes at the second tree-level towards a root node of the decision tree data structure;
compute probabilities of the one or more paths; and
output the values of the subset of plurality of attributes of the record along the path with highest probability as possible values.

18. The computer-readable storage medium of claim 17, wherein the first value comprises two or more values corresponding to two or more attributes of the record, and wherein the first attribute is selected from the two or more attributes as an attribute with a corresponding node in the decision tree data structure with the highest weight among weights assigned to nodes corresponding to the two or more attributes.

19. The computer-readable storage medium of claim 17, wherein a target attribute is a first target attribute corresponding to a first target tree-level, and wherein the instructions further configure the computer to:
traverse the path from the one or more nodes at the second tree-level towards the root node of the decision tree data structure until the first target tree-level is reached; and
in response to an attribute from the subset of the plurality of attributes not yet having a predicted value, traverse the path downwards from the first target tree-level to a second target tree-level corresponding to a second attribute from the subset of the plurality of attributes.

20. The computer-readable storage medium of claim 17, wherein generating the decision tree data structure comprises:
for each attribute in the record, determine an attribute type and computing an entropy based on the attribute type;
assign tree-levels to each attribute based on a sorted order of the entropies; and
for each tree-level, invoke a sub-tree generating algorithm for each node in the tree-level.
